(19) United States
(12) Patent Application Publication
(10) Pub. No.: US 2024/0143674 A1
(43) Pub. Date: May 2, 2024

(54) PROCESSING AND PUBLISHING SCANNED DATA FOR DETECTING ENTITIES IN A SET OF DOMAINS VIA A PARALLEL PIPELINE

(71) Applicant: OneTrust LLC, Atlanta, GA (US)

(72) Inventors: Raju Bokade, Atlanta, GA (US); Ravi Kalasapur, Atlanta, GA (US); Mithun Babu, Atlanta, GA (US); Austin Proctor, Atlanta, GA (US)

(21) Appl. No.: 18/476,185

(22) Filed: Sep. 27, 2023

Related U.S. Application Data
(60) Provisional application No. 63/381,173, filed on Oct. 27, 2022.

(51) Int. Cl. G06F 16/951; G06F 9/50

(52) U.S. Cl. CPC G06F 16/951; G06F 9/5027

(57) ABSTRACT

Methods, systems, and non-transitory computer readable storage media are disclosed for processing data for a subset of domains in parallel with publishing data to a tenant database for another subset of domains within a shared infrastructure. Specifically, the disclosed system assigns one or more partitions of an intermediate shared processing queue to a set of domains indicated by a scan request from a client device. The disclosed system extracts data from a subset of domains of the set of domains via the one or more partitions and publishes scan results of the subset of domains to the tenant database. Furthermore, the disclosed system extracts, in parallel with publishing the data of the subset of domains, additional data of an additional subset of domains via the one or more partitions of the intermediate shared processing queue.

### CROSS-REFERENCE TO RELATED APPLICATIONS

This application claims priority to and the benefit of U.S. Provisional Patent Application No. 63/381,173, filed on Oct. 27, 2022, which is incorporated herein by reference in its entirety.

### BACKGROUND

Advances in computer processing and data storage technologies have led to a significant increase in the amount and types of data moved to digital environments for processing. Specifically, many entities utilize computing devices and/or software applications to store, analyze, transmit, and/or perform a number of computing operations on different types of data, such as in connection with services that involve many devices communicating over a network to make requests for performing various processes. For example, entities that provide network security services or network privacy services to other entities via network requests can be in communication with computing devices to process electronic requests (e.g., web tag/cookie scanning and processing operations) associated with the services. Handling many such requests from various computing systems—sometimes thousands or hundreds of thousands of requests—can require a significant amount of computer processing power and time utilizing a finite amount of processing power. Furthermore, many entities utilize data from such requests to perform additional downstream operations, such as categorizing and/or presenting such data for display at one or more computing devices.

Conventional systems typically scan and process large amounts of data using processes that result in inefficiencies. For instance, conventional systems replicate scanned data and pass the replicated data from one computing system to another. In particular, for processing requests that contain a large amount of data, conventional systems typically take multiple days to make the replicated data and corresponding results available to a requestor. Moreover, because the conventional systems read the scanned data to an intermediate database and then copy the data from the intermediate database to a tenant database (e.g., a tenant SQL database), conventional systems take a significant amount of time and computational resources to accomplish these processing tasks and publish the results.

Furthermore, conventional systems processing such large amounts of data all at once can make it difficult to identify and/or correct failure points within the processing pipeline. In particular, processing large amounts of data can produce a high processing load at any of the computing devices within a computing system. Further, the high processing load can overload the computing devices within a computing system, resulting in accuracy concerns. In some instances, conventional systems attempt to write an amount of data larger than an intermediate database and/or tenant database can process or store, resulting in many failures. Accordingly, conventional systems often fail to identify at which stage during a processing task the computing system failed, resulting in additional delays due to repeated processing tasks and repeated failures of the same nature.

### SUMMARY

This disclosure describes various aspects for processing and publishing extracted data from computing devices associated with sets of domains in parallel. Specifically, the disclosed systems initialize a scanning operation for a set of domains by assigning partitions of an intermediate shared processing queue to process subsets of domains. The disclosed systems process and publish scanned data for various subsets of domains associated with the scanning operation in parallel utilizing the partitions of the intermediate shared processing queue. For example, in response to a scan request from a client device in connection with a set of domains, the disclosed systems assign one or more partitions (e.g., Kafka topics) of an intermediate shared processing queue to the scan request. Further, in some aspects, the disclosed system extracts first data from a batch (e.g., a first subset) of domains via the partitions of the intermediate shared processing queue and publishes the first data to a tenant database. Moreover, in some aspects, the disclosed system extracts second data for a second batch of domains in parallel with publishing the first data. By utilizing a parallel processing and publishing pipeline, the disclosed systems provide efficient processing and timely publishing of scanning results for detecting issues in the scanned data and for identifying errors in the pipeline.

### BRIEF DESCRIPTION OF THE DRAWINGS

Various aspects will be described and explained with additional specificity and detail through the use of the accompanying drawings.

FIG. 1 illustrates an example of a system environment in which a parallel web scanning system can operate in accordance with one or more aspects.

FIG. 2 illustrates an example of an overview of the parallel web scanning system publishing data corresponding to a first subset of domains to a tenant database in accordance with one or more aspects.

FIG. 3 illustrates an example of the parallel web scanning system assigning partitions of an intermediate shared processing queue in accordance with one or more aspects.

FIG. 4 illustrates an example of the parallel web scanning system utilizing a scan request threshold and assigning various partitions in accordance with one or more aspects.

FIG. 5 illustrates an example of the parallel web scanning system routing generating message(s) corresponding to scanned data to provide to a client device in accordance with one or more aspects.

FIG. 6 illustrates an example of the parallel web scanning system utilizing an intermediate replicator in accordance with one or more aspects.

FIG. 7 illustrates an example of a graphical user interface for managing scanning requests of the parallel web scanning system in accordance with one or more aspects.

FIG. 8 illustrates another example of a graphical user interface for viewing the status of one or more scanning requests in accordance with one or more aspects.

FIG. 9 illustrates an example of a process for extracting, in parallel with publishing a first data, second data in accordance with one or more aspects.

FIG. 10 illustrates an example of a computing device in accordance with one or more aspects.

### DETAILED DESCRIPTION

This disclosure describes one or more aspects of a parallel web scanning system that scans and processes web data utilizing a parallel data processing and publishing pipeline involving an intermediate shared processing queue. For example, the parallel web scanning system scans data at one or more domains and/or websites to collect and/or classify data at the domains/websites for one or more downstream operations involving the classified data. In one or more aspects, the parallel web scanning system receives a request to scan a domain or website for specific types of data. Further, in one or more aspects, the parallel web scanning system utilizes the intermediate shared processing queue to scan the domain/website (or a portion of the domain/website) and passes/publishes the data to a tenant database for review and/or additional data operations. Specifically, the parallel web scanning system performs operations to scan data via one or more partitions of the intermediate shared processing queue and publish the scanned data to the tenant database in parallel with continuing to scan other domains/websites (or other portions of the domain/website). Thus, the parallel web scanning system provides parallel scanning/processing operations that efficiently, accurately, and flexibly utilize computing resources to scan and process data while providing timely scanning results for the data.

In one or more aspects, the parallel web scanning system assigns one or more partitions of an intermediate shared processing queue for a number of domains within a scan request. In particular, in response to receiving a scan request from a client device, the parallel web scanning system determines a number of domains within the scan request to further determine a number of partitions to assign to the scan request. For instance, the parallel web scanning system can utilize an intermediate shared processing queue that contains many partitions for which the parallel web scanning system assigns a subset of the partitions to a scan request. Further, in some aspects, by assigning partitions based on a number of domains, the parallel web scanning system efficiently allocates the extracting of data in parallel with publishing the processed data.

In some aspects, the parallel web scanning system determines a classification of the scan request. For instance, the classification of the scan request includes a user-initiated scan request, a scheduled request, or a priority request. Further, the parallel web scanning system assigns the one or more partitions to the set of domains of the scan request based on the classification of the scan request. Specifically, the parallel web scanning system assigns a first set of partitions to a user-initiated scan request and a second set of partitions to a priority request. Thus, the parallel web scanning system can utilize different partitions of the intermediate shared processing queue to process different types of scan requests. Moreover, in some aspects, the parallel web scanning system further determines to prioritize certain types of scan request classifications over others.

In one or more additional aspects, the parallel web scanning system extracts data from a set of domains of a scan request. For instance, the parallel web scanning system extracts first data from a first subset of domains of the set of domains of the scan request by using one or more partitions of the intermediate shared processing queue. Specifically, the parallel web scanning system extracts first data that includes, but is not limited to, entities such as cookies, tags, forms, or storage. Moreover, the parallel web scanning system analyzes the cookies, tags, forms, or storage according to various internal or external standards associated with an entity initiating the scan request, such as security, privacy, legal, or ethical standards applicable to specific data types.

Further, in one or more aspects, the parallel web scanning system publishes the extracted first data from the first subset of domains to a tenant database associated with a client device that sent the scan request. For instance, the parallel web scanning system makes the extracted data available to the client device in response to processing the first data of the first subset of domains. By publishing the extracted first data from the first subset of domains in parallel with continuing to process second data from a second subset of domains, the parallel web scanning system increases efficiency and accuracy with viewing scanned data.

Additionally, in one or more aspects, the parallel web scanning system generates a message indicating information associated with the scan request. In particular, the message can include classification/processing results of scanned data of the set of domains, which the parallel web scanning system provides to the client device for review and/or further operations. For instance, based on the parallel web scanning system extracting first data for a first subset of domains and publishing the first data, the parallel web scanning also generates the message that corresponds to the first data to notify the client device regarding the completion of scanning and analyzing the first data for the first subset of domains. Moreover, in some aspects, the message indicates to the client device regarding the availability of the extracted data at the tenant database and results corresponding to the extracted data.

As mentioned above, the parallel web scanning system provides parallel processing and publishing of different subsets of data associated with a single scan request. For instance, the parallel web scanning system also extracts additional data associated with a second subset of domains while publishing data associated with the first subset of domains. Specifically, the parallel web scanning system provides one or more messages associated with the first data of the first subset of domains while scanning and processing second data from the second subset of domains. Accordingly, the parallel web scanning system continues to process portions of data associated with the scan request while also providing results of other portions of the scanning operations to the client device.

In one or more aspects, the parallel web scanning system improves upon shortcomings of conventional systems in relation to processing different types of data. For example, as mentioned above, the parallel web scanning system improves upon efficiency of computing system with regards to conventional systems. In particular, in contrast to conventional systems that suffer from delays in processing requests that contain a large amount of data (e.g., data that takes multiple days to process) by scanning/processing all data in a request prior to making results available, the parallel web scanning system provides timely publishing of scan results for scanned portions of data while continuing to process the remaining data. In some aspects, the parallel web scanning system overcomes these inefficiency issues by leveraging partitions of an intermediate shared processing queue to create a parallel processing/publishing pipeline for a scan request. To illustrate, in some aspects, the parallel web scanning system extracts first data from a first subset of the set of domains and publishes the first data of the subset of domains to a tenant database while extracting second data from a second subset of the set of domains in parallel with publishing the first data. In doing so, the parallel web scanning system makes data available to a client device as it is extracted/processed.

Moreover, in one or more aspects, the parallel web scanning system further improves upon inefficiencies of conventional systems via the parallel processing/publishing pipeline. For instance, as discussed above, conventional systems suffer from inefficiencies due to writing scanned data to an intermediate database and copying the data from the intermediate database to a tenant database after scanning the data, which takes significant time and computational resources. In contrast to the conventional systems, the parallel web scanning system can directly publish scanned data to a tenant database while continuing to extract additional data from a set of domains in a scan request in parallel. As such, the parallel web scanning system conserves computational resources by avoiding repetitive data copying tasks and utilizing an intermediate database. Processing and publishing results for different subsets of data in a scan request (e.g., via batching portions of a set of domains) can also allow the parallel web scanning system to relieve the computational burden on the tenant database by breaking a large dataset into smaller chunks that the tenant database can handle over time, rather than all at once.

Further, in some aspects, the parallel web scanning system improves upon accuracy concerns of conventional systems. For example, as mentioned, conventional systems suffer from process overloads by attempting to write an amount of data larger than the intermediate database and/or tenant database. In some aspects, the parallel web scanning system addresses these issues by performing parallel operations of publishing data of a first subset of domains to the tenant database and extracting data from a second subset of domains. By publishing data to the tenant database as it is scanned (e.g., in smaller batches) and continuing to scan data in parallel with publishing scanned data, the parallel web scanning system can ensure that errors detected in the scanned data or in the scanning operations are corrected in a timely manner.

Moreover, unlike conventional systems which fail to identify failures at various stages during a processing task, in some aspects the parallel web scanning system publishes data for different subset of domains of a scan request to a tenant database at different times according to the parallel processing/publishing pipeline. In doing so, the parallel web scanning system avoids all-or-nothing errors that often result from copying over large quantities of data. Instead, the parallel web scanning system breaks up the scan request into various subsets and publishes the data to the tenant database as it is processed while continuing to process additional subsets of data. Accordingly, the parallel web scanning system can identify specific failure points associated with specific subsets of data of the scan request while continuing to perform scanning operations to assist in detecting and preventing additional similar errors on other portions of a set of domains of the scan request.

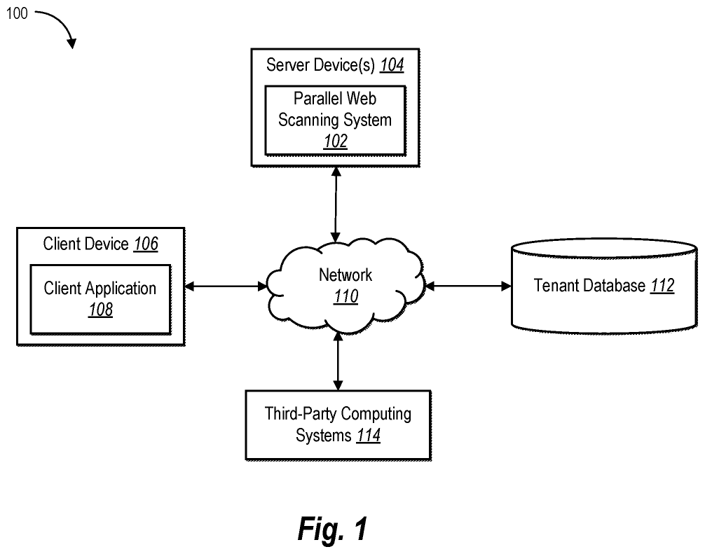

Turning now to the figures, FIG. 1 includes an aspect of a system environment 100 in which a parallel web scanning system 102 is implemented. In particular, the system environment 100 includes a server device(s) 104, a client device 106, a tenant database 112 in communication via a network 110, and third-party computing systems 114 in communication via the network 110. FIG. 1 also shows that the client device 106 includes client application 108.

As shown in FIG. 1, in one or more aspects, the server device(s) 104 can include or host the parallel web scanning system 102. Specifically, the parallel web scanning system 102 includes, or is part of, one or more systems that processes data from a set of domains for a scan request. For instance, the parallel web scanning system 102 receives the data from the set of domains from the third-party computing systems 114, which host the domains. For example, the parallel web scanning system 102 extracts and scans data from the domains to categorize the data in the domains for one or more downstream operations and/or for verifying controls associated with one or more system or data requirements. Additionally, the parallel web scanning system 102 publishes data associated with a subset of domains in parallel with continuing to process data for another subset of domains. In doing so, the parallel web scanning system 102 makes the published data available to the client device 106 via the tenant database 112.

Furthermore, in some examples, the parallel web scanning system 102 provides tools to the client device 106 for managing data associated with a set of domains. In one or more aspects, the parallel web scanning system 102 provides tools to the client device 106 via the client application 108 for configuring a scan request and for further viewing and managing information associated with data published to the tenant database 112. In one or more aspects, the parallel web scanning system 102 (or another system associated with the parallel web scanning system 102) provides tools for configuring scan requests and managing one or more computing devices and/or datasets published to the tenant database 112 for the subset of domains in connection with one or more downstream operations.

To illustrate, the parallel web scanning system 102 can perform scanning and classification operations in connection with one or more downstream operations involving data associated with a set of digital data requirements, which can include internal or external requirements for handling specific types of data. For example, the parallel web scanning system 102 can scan and classify data for downstream operations that ensure compliance with a set of regulations, standards, or laws that include, for example, a set of practices established by the International Organization for Standardization (“ISO”), internally by a particular organization (e.g., a multinational corporation), or a territory government (e.g., the European Union). Furthermore, because data processes that handle specific types of data within a computing environment, certain data types can have higher time sensitivity than other data types.

In one or more aspects, the parallel web scanning system 102 provides tools to manage data for a set of domains published to the tenant database 112 in view of the various digital data requirements. For instance, the parallel web scanning system 102 generates one or more data objects (e.g., a digital object) that represent a webpage and various entities of the webpage such as cookies, tags, forms, and storage. Further, the parallel web scanning system 102 generates the data object for tracking and managing requirements and controls associated with the digital data requirements, including requirements involving the handling, storage, and transmission of cookie data. Furthermore, the parallel web scanning system 102 can install controls associated with the specific requirements by managing additional data objects representing websites, entities of the website, or other data within a computing environment. To illustrate, specific controls can include computing operations for handling specific data types (e.g., cookies, tags, forms, storage of payment information, etc.) in downstream operations, such as cookie retention/deletion, form management, digital file sorting, encryption operations, or other processes.

Additionally, as used herein, the term “computing operation” refers to a computing process that performs one or more actions on specified data published to the tenant database 112. In some aspects, a computing operation includes modifying data (e.g., entities such as cookies, tags, forms, storage) published to the tenant database 112 or using the extracted data from a set of domains to modify other aspects of a domain (e.g., a banner display in response to a selection of accepting certain cookies). For example, the parallel web scanning system 102 utilizes a computing operation to copy entities of the webpage/domain, delete entities of the webpage/domain, or modify entities of a webpage/domain. To illustrate, a computing operation can include modifying an entity such as a storage source of a webpage to redact data in the storage source or encrypt the storage source (e.g., redacting or encrypting credit card information or personally identifiable information detected within a storage source which can include a data table).

The parallel web scanning system 102 can further communicate with the client device 106 via the client application 108 to inform the client device 106 regarding data published to the tenant database 112. For instance, in response to extracting, analyzing, and/or processing data associated with a subset of domains, the parallel web scanning system 102 generates a message to send via the network 110 to the client device 106. In particular, the message contains details corresponding with the data extracted for the subset of domains.

Furthermore, the parallel web scanning system 102 can communicate with the client device 106 to obtain information associated with entities of the webpage/domain or to provide information about the entities of the webpage/domain for display within the client application 108. For instance, the parallel web scanning system 102 can obtain, via user input received from the client device 106, metadata or other information about the entities of the webpage/domain and/or operations involving the entities, such as for a scanning request to identify high priority entities.

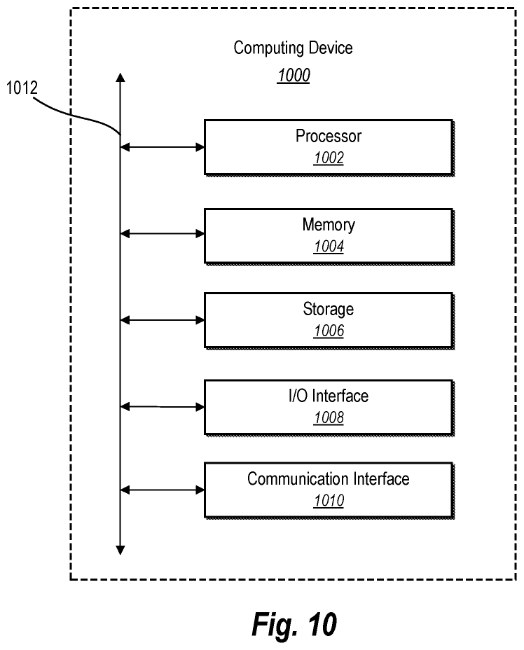

In one or more aspects, the server device(s) 104 includes a variety of computing devices, including those described below with reference to FIG. 10. For example, the server device(s) 104 includes one or more servers for storing and processing data associated with one or more data processes. In some aspects, the server device(s) 104 can also include a plurality of computing devices in communication with each other, such as in a distributed storage environment. In some aspects, the server device(s) 104 include a content server. The server device(s) 104 also optionally includes an application server, a communication server, a web-hosting server, a social networking server, a digital content campaign server, or a digital communication management server.

In one or more aspects, the client device 106 includes, but is not limited to, a desktop, a mobile device (e.g., smartphone or tablet), or a laptop including those explained below with reference to FIG. 10. Furthermore, although not shown in FIG. 1, the client device 106 can be operated by users (e.g., a user included in, or associated with, the system environment 100) to perform a variety of functions. In particular, the client device 106 performs functions such as, but not limited to, accessing, viewing, and interacting with entities of webpages/domains and/or data processes involving the entities. In some aspects, the client device 106 also perform functions for generating, capturing, or accessing data to provide to the parallel web scanning system 102 in connection with processing the entities of the webpages/domains. For example, the client device 106 communicates with the server device(s) 104 via the network 110 to provide information (e.g., user interactions) associated with the entities. Although FIG. 1 illustrates the system environment 100 with a single client device, in some aspects, the system environment 100 includes a plurality of client devices. In some aspects, the client device 106 or the server device(s) 104 also host the tenant database 112.

Additionally, as shown in FIG. 1, the system environment 100 includes the network 110. The network 110 enables communication between components of the system environment 100. In one or more aspects, the network 110 may include the Internet or World Wide Web. Additionally, the network 110 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 104, the client device 106, and the tenant database 112 communicate via the network 110 using one or more communication platforms and technologies suitable for transporting data and/or communication signals, including any known communication technologies, devices, media, and protocols supportive of data communications, examples of which are described with reference to FIG. 10.

Although FIG. 1 illustrates the server device(s) 104, the client device 106, and the tenant database 112 communicating via the network 110, in alternative aspects, the various components of the system environment 100 communicate and/or interact via other methods (e.g., the server device(s) 104, the client device 106, and/or the tenant database 112 can communicate directly).

In some aspects, the server device(s) 104 support the parallel web scanning system 102 on the client device 106. For instance, the server device(s) 104 generates/maintains the parallel web scanning system 102 and/or one or more components of the parallel web scanning system 102 for the client device 106. The server device(s) 104 provides the generated parallel web scanning system 102 to the client device 106 (e.g., as a software application/suite). In other words, the client device 106 obtains (e.g., download) the parallel web scanning system 102 from the server device(s) 104. At this point, the client device 106 is able to utilize the parallel web scanning system 102 to process and/or manage data for digital content items of domains independently from the server device(s) 104.

In alternative aspects, the parallel web scanning system 102 includes a web hosting application that allows the client device 106 to interact with content and services hosted on the server device(s) 104. To illustrate, in one or more aspects, the client device 106 access a web page supported by the server device(s) 104. The client device 106 provides input to the server device(s) 104 to perform data processing operations, and, in response, the parallel web scanning system 102 on the server device(s) 104 performs operations to view/manage data associated with digital data processing. The server device(s) 104 provide the output or results of the operations to the client device 106.

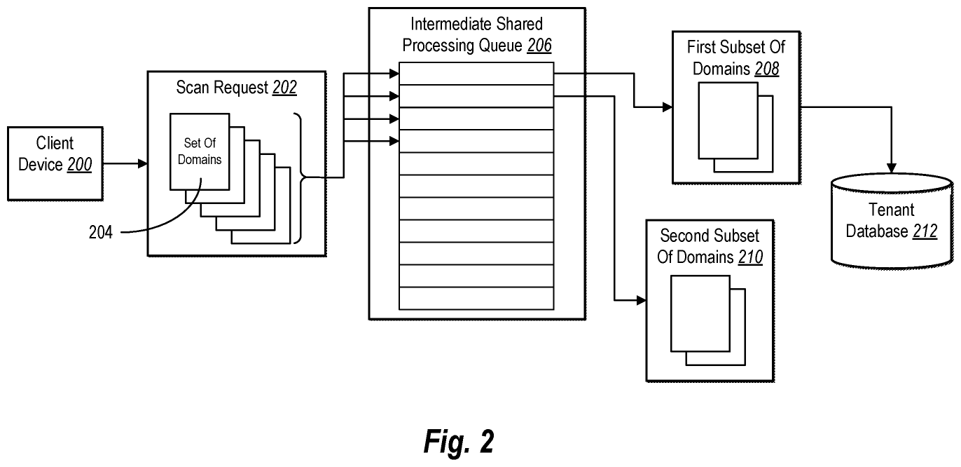

As mentioned above, the parallel web scanning system 102 processes web data utilizing a parallel data processing and publishing pipeline involving an intermediate shared processing queue. FIG. 2 illustrates an overview of the parallel web scanning system 102 scanning and publishing data from a first subset of domains to a tenant database in accordance with one or more aspects. FIG. 2 further illustrates that the parallel web scanning system 102 scans data from a second subset of domains in parallel with publishing the data from the first subset of domains.

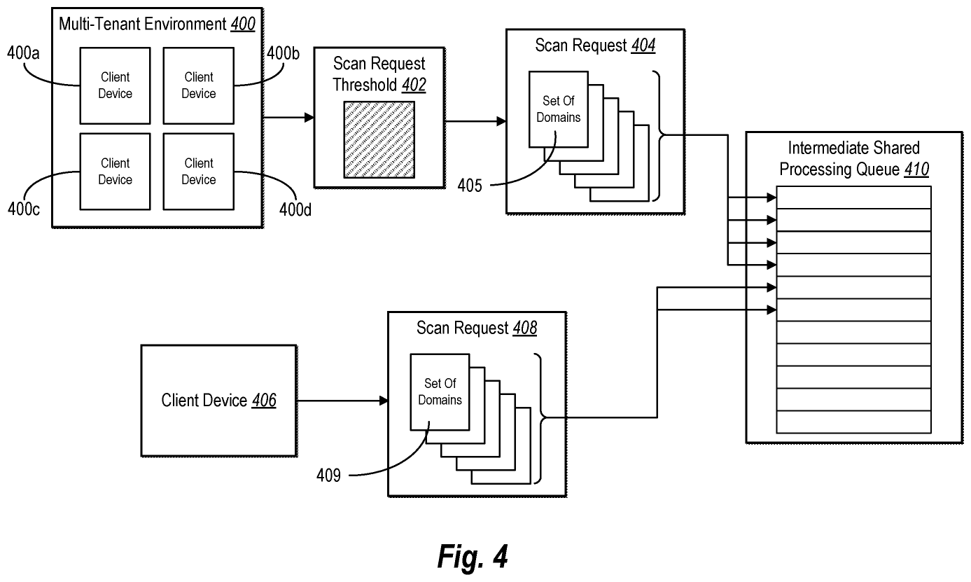

As shown in FIG. 2, the parallel web scanning system 102 receives a scan request 202 from a client device 200. In one or more aspects the client device 200 includes a computing device associated with a specific tenant environment (e.g., where a user or administrator of a platform can utilize a computing device associated with the specific tenant environment) and/or a server device. In particular, a tenant environment can include a logically separated computing environment including one or more computing devices, such that a plurality of tenant environments each operate within logically separated environments. Further, in some aspects, the client device 200 (e.g., a computing device within the specific tenant environment) is part of an entity or organization. In some aspects, the tenant environment is part of a multi-tenant environment, as discussed in more detail below in FIG. 4.

As shown, the parallel web scanning system 102 receives electronic requests from the client device 200 in the specific tenant environment. As used herein, an “electronic request” (or simply “request”) refers to a communication from a first computing device to a second computing device to perform a computing operation. In one or more aspects, an electronic request from a client device of the tenant environment includes a packet or message sent to the parallel web scanning system 102 (e.g., via an application programming interface (“API”)) provided by the parallel web scanning system 102 and including processing instructions to perform one or more scanning operations and/or replication operations. For instance, an electronic request can include a request to scan web data from one or more webpages, websites, or web domains and/or a request to replicate, process, analyze, and/or categorize specific types of data from the web data.

As mentioned above, the parallel web scanning system 102 receives the scan request 202. For instance, the scan request 202 includes a request to crawl through a set of domains 204 or websites to collect data associated with the set of domains or websites. Further, the parallel web scanning system 102 utilizes software programs and/or scripts to gather data (e.g., crawl through the set of domains or websites). Moreover, the software programs and/or scripts utilized by the parallel web scanning system 102 scan domains or webpages by visiting associated website links and indexing the content within the links (e.g., entities such as cookies, tags, forms, storage, etc.).

As further shown in FIG. 2, the parallel web scanning system 102 assigns a number of partitions of an intermediate shared processing queue 206 to the scan request 202. For instance, the intermediate shared processing queue 206 includes a task queue to scan data associated with the scan request 202. Further, the intermediate shared processing queue 206 includes a data structure that queues different portions (e.g., batches) of the scan request 202 and processes the different portions (e.g., subsets) in the order added to the queue.

To illustrate, in some aspects the intermediate shared processing queue 206 includes a combination of a data structure and program code with one or more computing devices (e.g., servers) to perform actions for processing data associated with one or more tenant environments. For instance, the actions include executing code that i) receives the scan request 202, ii) processes the scan request 202, iii) assigns the scan request to one or more partitions of the intermediate shared processing queue 206, iv) and extracts data from websites or domains associated with the scan request. Accordingly, the parallel web scanning system 102 utilizes the intermediate shared processing queue 206 to extract data from a subset of domains of the set of domains 204 and passes the extracted data to another component while processing another subset of the set of domains 204.

Specifically, FIG. 2 shows the parallel web scanning system 102 assigning four partitions of the intermediate shared processing queue 206 to the scan request 202. For example, a partition of the intermediate shared processing queue 206 includes a division or separation of processing capabilities of a hardware processing structure (e.g., a partition in a Kafka topic). In particular, a partition in this context can include a subset of one or more processors or servers of the intermediate shared processing queue 206 data structure that perform computing operations on a set of data. For instance, a partition of the intermediate shared processing queue 206 includes a dedicated portion of the data structure (e.g., a processor, a processor thread, or a server) for processing a specific subset of data related to the scan request 202. To illustrate, the intermediate shared processing queue 206 can include hundreds of partitions, a subset of which the parallel web scanning system 102 assigns to the scan request 202. Moreover, in some aspects the partition of the intermediate shared processing queue 206 includes dividing a computational task into individual sub-tasks for concurrent processing via multiple processors, threads, or servers of the intermediate shared processing queue 206.

Moreover, FIG. 2 shows the parallel web scanning system 102 extracting first data from a first subset of domains 208 of the set of domains 204 utilizing a first partition of the intermediate shared processing queue 206. For instance, FIG. 2 also shows the parallel web scanning system 102 publishing the first data from the first subset of domains 208 to a tenant database 212. For example, the tenant database 212 includes a database that stores data for a specific tenant environment within a shared networking infrastructure. For instance, in some aspects, the tenant database 212 only allows access to the authorized users and/or client devices 200 associated with the specific tenant environment that submitted the scan request 202.

Additionally, as further shown in FIG. 2, the parallel web scanning system 102 extracts second data from a second subset of domains 210 of the set of domains 204 utilizing a second partition of the intermediate shared processing queue 206. Specifically, the parallel web scanning system 102 extracts the second data from the second subset of domains 210 in parallel with publishing the first data of the first subset of domains 208 to the tenant database 212. In some embodiments, the parallel web scanning system 102 processes the first subset of domains 208 utilizing a set of partitions and the second subset of domains 210 utilizing the same set of partitions after finishing processing the first subset of domains 208. Accordingly, the parallel web scanning system 102 can utilize a plurality of partitions of the intermediate shared processing queue 206 to process the first subset of domains 208 followed by the second subset of domains 210 while publishing the results of the first subset of domains 208 to the tenant database 212.

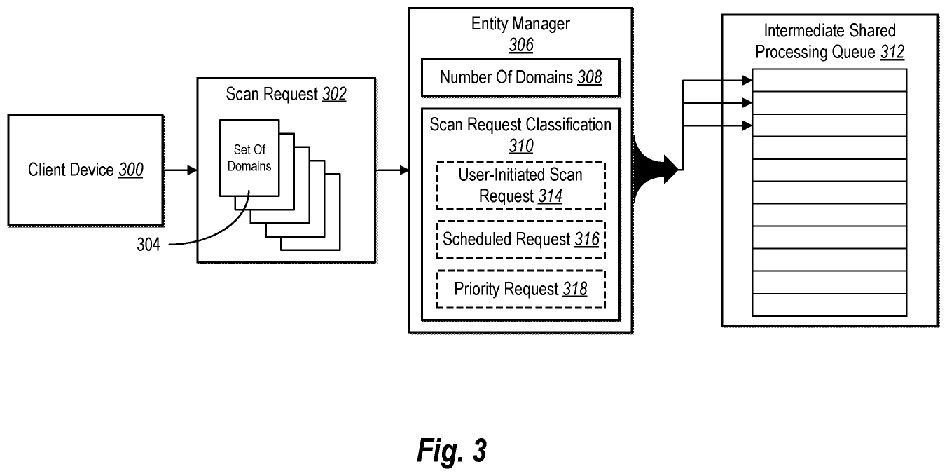

As mentioned above, the parallel web scanning system 102 assigns one or more partitions of an intermediate shared processing queue based on different aspects of a scan request. FIG. 3 illustrates the parallel web scanning system 102 determining a number of partitions of an intermediate shared processing queue to assign to a scan request in accordance with one or more aspects.

As discussed above, the parallel web scanning system 102 receives a scan request 302 from a client device 300. Further, as shown, the scan request 302 includes a set of domains 304. In one or more aspects, a domain includes a unique (and in some cases, a human-readable) name used to identify and locate a specific website or server. For instance, a domain includes a domain name and a domain extension that contains a series of alphanumeric characters. Further, for the domain “website.com”, “website” is the domain name while “.com” is the domain extension.

In some aspects, a domain includes a network domain (e.g., a domain name of a website indicated by a URL). In addition, the set of domains 304 includes one or more domains. For instance, the set of domains 304 can include a plurality of domains related to “website.com.” Specifically, the set of domains 304 can include website.com and variations that contain website.com such as website.com/product, website.com/account, and website.com/menu. Additionally, a domain can include one or more webpages/websites accessible via one or more URLs corresponding to the domain. Moreover, as mentioned above, in some aspects, the parallel web scanning system 102 extracts data from a subset of domains. For instance, a subset of domains includes a portion of the set of domains.

As shown in FIG. 3, the parallel web scanning system 102 utilizes an entity manager 306 to receive the scan request 302 with the set of domains 304. In particular, the entity manager 306 determines a processing load size of the scan request 302 to assist the parallel web scanning system 102 in determining the number of partitions to assign to the scan request 302. For instance, as shown, the entity manager 306 determines a number of domains 308 associated with the set of domains 304. To illustrate, for a higher number of domains, the parallel web scanning system 102 can assign a greater number of partitions of an intermediate shared processing queue 312.

Furthermore, FIG. 3 also shows the entity manager 306 determining a scan request classification 310. For instance, the parallel web scanning system 102 determines the scan request classification 310 by determining whether the client device 300 indicated a user-initiated scan request, a scheduled request, or a priority request. Accordingly, based on the parallel web scanning system 102 determining the number of domains 308 and the scan request classification 310, the parallel web scanning system 102 intelligently determines a number of partitions to assign to the scan request 302. Specifically, the parallel web scanning system 102 balances factors such as computational load, processing time, and number of other scan requests in determining a number of partitions to assign to the scan request 302.

To illustrate, the parallel web scanning system 102 can determine to assign a single partition for every one hundred domains included within the scan request 302. For instance, if the set of domains 304 of the scan request 302 contains two hundred domains, the parallel web scanning system 102 assigns two partitions to the scan request 302. Further, in some aspects, the parallel web scanning system 102 determines to assign additional partitions to specific types of scan request classifications. For instance, if the set of domains contains two hundred domains and the parallel web scanning system 102 classifies the scan request as a priority request, the parallel web scanning system 102 can assign a total of four partitions. As shown in FIG. 3, the parallel web scanning system 102 assigns three partitions of the intermediate shared processing queue 312 to the scan request 302.

As mentioned above, the parallel web scanning system 102 assigns partitions to a scan request based on the scan request classification. FIG. 3 further shows the scan request classification 310 including a user-initiated scan request 314, a scheduled request 316, or a priority request 318. In one or more aspects, the parallel web scanning system 102 assigns different scan request classifications to different partitions of an intermediate shared processing queue.

In one or more aspects, a plurality of tenant computing systems provides a plurality of requests (e.g., three scan requests) to an intermediate shared processing queue 312 of the parallel web scanning system 102. The parallel web scanning system 102 can determine a request type associated with each request (e.g., user-initiated, scheduled, priority). In some aspects, the parallel web scanning system 102 also separates the different request types into different request queues.

In one or more aspects, the parallel web scanning system 102 receives a first scan request classified as a user-initiated scan request 314. In one or more aspects, the user-initiated scan request 314 includes the client device associated with a specific tenant environment submitting a scan request. For instance, the parallel web scanning system 102 provides an option to the client device via the specific tenant environment to submit the scan request after indicating the relevant set of domains and various rules to apply during the scan. Accordingly, the user-initiated scan request 314 includes a standard submission (e.g., with a default priority level) to the parallel web scanning system 102 to scan a set of domains.

Further, in one or more aspects, the parallel web scanning system 102 receives a second scan request classified as a scheduled request 316. In one or more aspects, the scheduled request 316 includes a request to perform a scan sometime in the future. For instance, the parallel web scanning system 102 provides an option to the client device to indicate a date and time in the future to perform the scan request.

Moreover, in one or more aspects, the parallel web scanning system 102 receives a third scan request classified as a priority request 318. In one or more aspects, the priority request 318 includes the client device indicating via the specific tenant environment a scan request to be at the front of a queue. For instance, in some aspects, the parallel web scanning system 102 can override one or more other requests in the queue from one or more client devices associated with the specific tenant environment in response to receiving the priority request 318 (e.g., indicating a high priority level). In additional embodiments, in response to the priority request 318, the parallel web scanning system 102 can stop processing a scan request corresponding to a request with a low or default priority level and begin to scan data for the scan request corresponding with the priority request 318.

In one or more aspects, the parallel web scanning system 102 utilizes an intermediate shared processing queue 312 to assign scans to queues/partitions based on order of scanning priority. In particular, the parallel web scanning system 102 sends a plurality of scans to one or more partitions of the intermediate shared processing queue 312 (e.g., partitions of one or more Kafka topics). For instance, as shown, the parallel web scanning system 102 receives the priority request 318 after the user-initiated scan request 314 and the scheduled request 316, but the parallel web scanning system 102 can begin processing the priority request 318 first.

Furthermore, each partition of the intermediate shared processing queue 312 includes a processing queue for determining an order of processing data (e.g., based on order of insertion into the processing queue). Accordingly, the parallel web scanning system 102 includes a plurality of different queues for processing scanned web data in parallel (e.g., in parallel with other processing queues, in parallel with scanning additional web data associated with one or more scan requests, and/or in parallel with publishing processed data).

In one or more aspects, the parallel web scanning system 102 determines a plurality of available partitions for a particular scan request. To illustrate, the parallel web scanning system 102 assigns a subset of total partitions to a particular request (e.g., eight partitions from 50-100 total partitions). In one or more aspects, the parallel web scanning system 102 assigns different requests to different topics—e.g., user-initiated requests to a first Kafka topic, scheduled requests to a second Kafka topic, and priority requests to a third Kafka topic, as determined by a scanner system.

In one or more aspects, a Kafka topic refers to a group of partitions of the intermediate shared processing queue 312. For instance, a Kafka topic can utilize different scanning components of the intermediate shared processing queue 312 to process a scan request (e.g., a priority request 318 can utilize different scanner components to extract data from a set of domains than a scheduled request 316). By utilizing different scanner components for different Kafka topics, the parallel web scanning system 102 can perform parallel processing for different scan requests. In other words, each Kafka topic can include a plurality of separate partitions (e.g., separate queues).

In one or more aspects, the parallel web scanning system 102 assigns priority values based on the type of requests. For instance, the parallel web scanning system 102 assigns a higher priority value to priority requests and user-initiated requests and a lower priority value to scheduled requests. Further, the parallel web scanning system 102 utilizes the intermediate shared processing queue 312 to scan and process data for requests with higher priority first to prevent lower priority requests from clogging the intermediate shared processing queue 312.

In one or more aspects, the parallel web scanning system 102 dynamically determines partitions for processing scanned data for a particular scan request. To illustrate, in response to determining that the intermediate shared processing queue has 100 total partitions, the parallel web scanning system 102 can assign a specific subset of partitions of the 100 total partitions to the scan request (e.g., partitions 10-17). By assigning a plurality of partitions to the scan request, the parallel web scanning system 102 can utilize the intermediate shared processing queue 312 to process data in the scan request in parallel while efficiently utilizing the processing resources (e.g., without overloading any given partition or leaving one or more partitions unused).

According to one or more aspects, the parallel web scanning system 102 provides dynamic scaling. For example, the parallel web scanning system 102 increases internet protocol ranges (e.g., IP ranges) for one or more pools (e.g., batches of scan requests) associated with one or more Kafka topics (e.g., user-initiated, priority, or scheduled) on demand. In particular, the parallel web scanning system 102 creates a separate set of pools corresponding to priority scans, scheduled scans, and user-initiated scans. The parallel web scanning system 102 can also break down IP ranges into different pools—e.g., a first set of IP ranges for one or more pools corresponding to priority scans, a second set of IP ranges for one or more pools corresponding to scheduled scans, and a third set of IP ranges for one or more pools corresponding to user-initiated scans.

In some instances, a client device associated with a specific tenant environment escalates a scan request to complete the scan more quickly. Accordingly, the parallel web scanning system 102 allocates the scan request to the priority pool. The parallel web scanning system 102 can also create a separate schedule for user-initiated scans and assign each a set of one or more IP addresses to ensure that the higher priority scan is completed more quickly. Furthermore, in some aspects, the parallel web scanning system 102 increases the IP ranges to allow for more scans to run in parallel (e.g., more scans by a single client device of a specific tenant environment or more scans by a plurality of client devices of a specific tenant environment).

FIG. 4 illustrates the parallel web scanning system 102 receiving a scan request from a client device of a specific tenant environment of a multi-tenant environment and an additional scan request from another client device of another specific tenant environment external to the multi-tenant environment in accordance with one or more aspects. In particular, as shown in FIG. 4, the parallel web scanning system 102 receives a scan request 404 corresponding with a set of domains 405 from a multi-tenant environment 400.

As just mentioned, in some aspects, a client device is part of a specific tenant environment of the multi-tenant environment 400. For instance, the multi-tenant environment 400 includes multiple users or entities, referred to as tenants, that share computing resources but maintain security and isolation with respect to each tenant environment's respective applications and data. Accordingly, a tenant environment in the multi-tenant environment 400 shares the computational infrastructure with other tenant environments while maintaining its own separate computing environment. To illustrate, the multi-tenant environment 400 in FIG. 4 includes client devices 400a-400d corresponding to separate respective tenant environments.

Further, as shown, for the multi-tenant environment 400, the parallel web scanning system 102 utilizes a scan request threshold 402 to assign scan requests to portions of a shared computational infrastructure. In particular, the scan request threshold 402 includes the parallel web scanning system 102 predetermining a number of requests per tenant environment of the multi-tenant environment 400. For instance, the parallel web scanning system 102 predetermines a number of requests per tenant environment of the multi-tenant environment 400 to ensure that a single tenant environment does not consume an outbalanced number of computational resources. Specifically, the parallel web scanning system 102 can utilize the scan request threshold 402 to ensure that the scan requests available to tenant environments are evenly distributed for the multi-tenant environment 400.

In one or more aspects, the parallel web scanning system 102 throttles the number of scans to efficiently utilize computing resources. To illustrate, the parallel web scanning system 102 performs partition level throttling by size of the scan request. Scan throttling can prevent a single request (e.g., a single client device in the multi-tenant environment 400) from utilizing an outsized percentage of resources relative to other scan requests.

Specifically, the parallel web scanning system 102 determines a scan level configuration when performing scans. For example, the scan level configuration can define a default for scan throttling (e.g., until overridden at the tenant level), including determining a number of scans per tenant (e.g., 10)—for either or both user-initiated scans and scheduled scans. Accordingly, in response to determining that a scan request fails to satisfy the scan request threshold 402 (e.g., the scan request 404 exceeds a number of scans allocated per tenant), the parallel web scanning system 102 throttles the scan request 404, such as by limiting a number of partitions for the scan request 404, delaying the scan request 404 in a queue, or lowering a priority of the scan request 404.

Additionally, in one or more aspects, the parallel web scanning system 102 can determine a tenant level configuration in which a tenant (e.g., a tenant environment) can request more than the default scan limit as determined by the scan request threshold 402. For example, the parallel web scanning system 102 can store the tenant level configuration in a new table in the tenant database, which can include updating/changing the new table using an operational transformation arbiter (e.g., OT-arbiter—one each for user initiated and scheduled scans that receives and processes operations from each client device). The parallel web scanning system can refer to the tenant level configuration when additional scans over the scan limit are triggered (and in the held/queued status).

To illustrate, as shown in FIG. 4, the parallel web scanning system 102 determines that the scan request 404 from a single client device (e.g., from a single tenant environment) of the multi-tenant environment 400 satisfies the scan request threshold 402. Further, in response to determining that the scan request 404 satisfies the scan request threshold 402, the parallel web scanning system 102 assigns the scan request 404 to several partitions (e.g., four partitions) of an intermediate shared processing queue 410.

Further, as shown in FIG. 4, the parallel web scanning system 102 receives an additional scan request (e.g., the scan request 408) with a set of domains 409 from a client device 406 of a specific tenant environment. In contrast to the scan request 404, the parallel web scanning system 102 does not utilize the scan request threshold 402 for the scan request 408 because it comes from the client device 406 associated with a specific tenant environment in a non-multi-tenant environment. Moreover, FIG. 4 shows the parallel web scanning system 102 assigning two partitions of the intermediate shared processing queue 410 to the scan request 408.

In one or more aspects, the parallel web scanning system 102 stores new scan requests from a particular tenant environment with a “HELD/QUEUED” status in response to receiving the requests. Additionally, the parallel web scanning system 102 moves the requests to a “SCANNING” status in response to selecting a request for scanning. In response to reaching a scan limit for a particular tenant environment, the parallel web scanning system 102 can wait for a current active scan to complete before picking up a “HELD/QUEUED” scan for scanning.

In one or more aspects, in response to completing a scan or in case of scans that are canceled or aborted due to error for a tenant environment, the parallel web scanning system 102 determines whether there are any “HELD/QUEUED” scans. If there are scans with a “HELD/QUEUED” status, the parallel web scanning system 102 can select the oldest scan request. For example, the parallel web scanning system 102 (or a component of the parallel web scanning system 102 that manages entities detected in web data) invokes a scanning API to trigger the scan. In additional aspects, the parallel web scanning system 102 can provide for manual intervention for specific scans or scans that are stuck with “HELD/QUEUED” status, such as by utilizing an API to retrigger the scans.

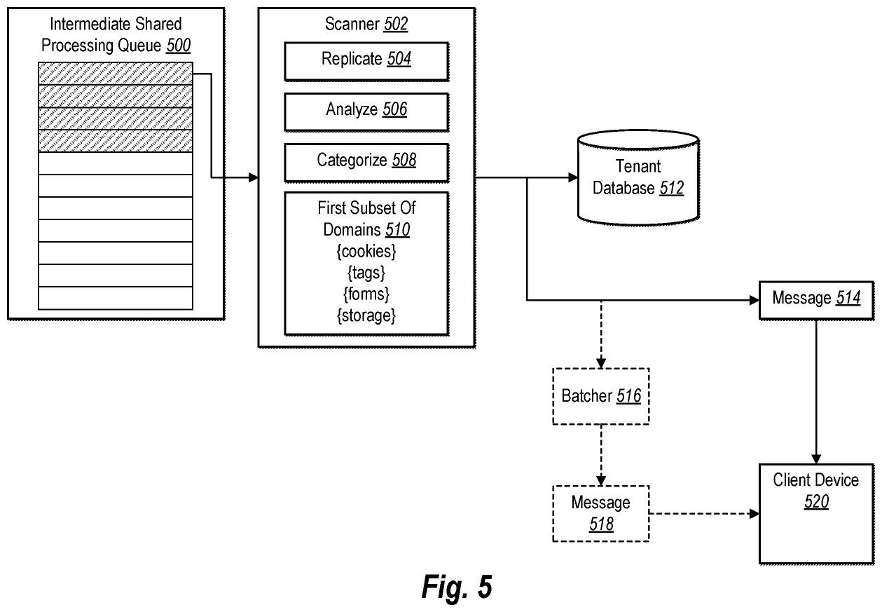

As mentioned above, the parallel web scanning system 102 extracts data from a set of domains to provide results to a client device associated with a specific tenant environment for use in one or more downstream operations involving the extracted/classified data. FIG. 5 illustrates the parallel web scanning system 102 extracting data from a subset of domains and sending a message to a client device associated with a specific tenant environment in accordance with one or more aspects. For example, FIG. 5 shows the parallel web scanning system 102 assigning partitions of an intermediate shared processing queue 500 to a scan request.

Further, FIG. 5 shows the parallel web scanning system 102 utilizing a first partition of the intermediate shared processing queue 500 to extract data from a first subset of domains 510. In particular, FIG. 5 shows the parallel web scanning system 102 passing the first subset of domains 510 to a scanner 502. For instance, the scanner 502 scans web data from one or more domains, web sites, or web pages in response to a scan request.

For example, in response to a request by a client device 520 (e.g., an explicit user-initiated scan request or a scheduled request), the scanner 502 scans the web data to identify entities of one or more entity types—e.g., cookies, tags, forms, storages. To illustrate, the scanner 502 crawls through pages of a web site and collects data of the various entity types. In one or more aspects, the scanner 502 includes the intermediate shared processing queue 500 for scanning/processing portions of a plurality of scans in parallel.

As shown in FIG. 5, the scanner 502 can perform a variety of acts that includes replicating data 504, analyzing data 506, and categorizing data 508 of the first subset of domains 510. For instance, replicating data 504 includes creating and maintaining identical copies of data across the set of domains of the scan request scanned by the parallel web scanning system 102. To illustrate, one potential goal of replicating data 504 across the set of domains is to maintain a log of the data for a set of domains during a specific time frame.

Further, in some instance, analyzing data 506 includes determining the type of data that activates upon certain actions, the type of information collected at a domain, the manner of storage, the integrity of the code structure, and the viewability of the domain. Moreover, in some instances, the parallel web scanning system 102 categorizes data 508 by identifying a number of cookies, a number of tags, forms, or storages.

In one or more aspects, the parallel web scanning system 102 utilizes the intermediate shared processing queue 500 to categorize the scanned data according to the scan request. Specifically, the parallel web scanning system 102 utilizes the intermediate shared processing queue 500 to process a particular message by identifying an entity, an entity type, and/or other information about an entity from the scanned data. To illustrate, the parallel web scanning system 102 determines a name, host, resource, and/or security level of the entity based on the scanned data. The parallel web scanning system 102 can store the categorization information associated with each entity in an index of a tenant database 512.

As an example, the parallel web scanning system 102 scans a domain or website in response to a scan request by crawling through webpages of the website and collecting data (e.g., cookies). The parallel web scanning system 102 performs a categorization operation on the collected cookies and buckets the cookies (e.g., based on cookie type). The parallel web scanning system 102 can then relay the categorization data to a banner placed on the website. When a user opens the website on a client device (e.g., within a web browser), the host presents the banner with options to block one or more categories of entities (e.g., one or more cookie types) during loading and presentation of the banner. Accordingly, when loading the banner during presentation of the website on the client device, the selected settings prevent any blocked categories of cookies from being loaded with the banner.

In one or more aspects, in scanning the first subset of domains 510, the parallel web scanning system 102 generates data objects. As used herein, the term “data object” refers to a digital object for tracking or managing systems, software, data sources, entities, or other functions or infrastructure involved in handling specified data for an entity. For example, a data object can include a digital representation of the entity itself, a sub-entity such as subsidiary of the entity, a business unit of the entity, a data asset, a project, a machine-learning model, a dataset, or a computing operation such as a data process. In some aspects, a data object includes a “common data object” representing implementation details for a machine-learning model in connection with data processes. For example, a common data object includes a digital file with attribute values corresponding to a machine-learning model and one or more datasets associated with the machine-learning model. Additionally, or alternatively, the common data object includes links to one or more additional data objects based on relationships between a machine-learning model and datasets, assessments, or risk analyses.

For instance, the parallel web scanning system 102 utilizes the scanner 502 to scan a single domain of the first subset of domains 510 and generates a data object to represent the single domain. Furthermore, the data object generated to represent the single domain can include sub-portions that contain various entities such as cookies, tags, forms, or storage of the single domain (e.g., a domain data object or a cookie data object). In one or more examples, the parallel web scanning system 102 also generates additional data objects to represent the individual elements in a domain, such as data objects representing the individual cookies, tags, etc.

In one or more aspects, a cookie includes a piece of data created for a domain or website and stored on a user's computing device that visits the website or domain. For instance, a cookie includes a piece of data that stores information about a user's preferences. Specifically, the cookie can store login credentials, shopping cart items, and language preferences. Further, cookies include key-value pairs that a server can read and write to customize a browsing experience for a user of a computing device.

In one or more aspects, a tag includes a snippet of code or a script on a domain or website. For instance, a tag can be placed on a domain or website by a third-party analytics platform to collect user data. Specifically, upon a user visiting a domain or website, the tag captures information associated with a user that is relevant to the third-party analytics platform.

In one or more aspects, forms include an interactive element on a domain or website that allows a user to input and submit data. For instance, a form includes text inputs, checkboxes, radio buttons, dropdown menus, and submit buttons. Furthermore, a form can include a file upload option, date pickers and human-checking mechanisms (e.g., CAPTCHA).

In one or more aspects, storage on a website or domain includes the allocation of space on a server to store files, data or other items within the website or domain. For instance, in some aspects, a user of a computing device submits information to a website which stores the information on storage servers. Further, in some aspects, certain data processes require payment information or personally identifiable information to not be stored or to be stored in a certain manner (e.g., stored separately from other data, encrypted, stored in specific locations accessed via specific credentials).

As shown in FIG. 5, in response to extracting first data from the first subset of domains 510 (e.g., the first data including cookies, tags, forms, and/or storage), the parallel web scanning system 102 publishes the first data of the first subset of domains 510 to the tenant database 512. The parallel web scanning system 102 continues to extract second data from a second subset of domains via one or more partitions of the intermediate shared processing queue 500 in parallel with publishing the first data to the tenant database 512 (e.g., via the first partition utilized for the first subset of domains 510 or a second partition).

In one or more aspects, the parallel web scanning system 102 performs tenant database utilization optimization to optimize/reduce CPU usage of one or more tenant databases (e.g., by preventing CPU utilization for staying at 100% usage for a long duration). Specifically, the parallel web scanning system 102 generates an index based on unique characteristics of the extracted entities. For example, in response to determining that a particular entity from web data of a scanned subset of domains includes specific details, the parallel web scanning system 102 can organize the entity according to the extracted details (e.g., based on columns of a database table).

In particular, extracted details can include many characters, resulting in the extracted data exceeding character limits of certain computing processes. Accordingly, the parallel web scanning system 102 can generate a hash value/key based on the details extracted for the entity and enter the hash value into a hashed index. To illustrate, the parallel web scanning system 102 can generate a hash value based on a name, a host, and a security flag for a cookie extracted from the web data. The resulting hashed index results in faster database searches for the entities than without hashing the scanned data.

In one or more aspects, a hash value includes a fixed numerical representation of data generated via a hash function. For instance, the parallel web scanning system 102 takes one or more entities that exceeds a number of predetermined characters and applies a mathematical algorithm to produce a unique fixed length output. Moreover, the parallel web scanning system 102 utilizes a hash value in hash tables and other data structures for fast retrieval and storage optimization.

Moreover, in some aspects based on the parallel web scanning system 102 publishing the hash value to the tenant database, the parallel web scanning system 102 further generates a message to provide to the client device 520 associated with the specific tenant environment regarding the published hash value. Specifically, the parallel web scanning system 102 can publish the hash value to the tenant database and generate a message indicating the publishing to the tenant database to notify the client device 520 of the publication. Further, in some aspects, the user/administrator of the client device 520 of a specific tenant environment accesses the published hash value in the tenant database, which causes the parallel web scanning system 102 to decrypt the hash value.

Furthermore, as shown in FIG. 5, in addition to publishing the first data of the first subset of domains 510 to the tenant database 512, the parallel web scanning system 102 also generates a message 514. In one or more aspects, the parallel web scanning system 102 sends the message 514 to the client device 520 of a specific tenant environment. For instance, the message 514 includes an indication of data published to the tenant database 512. Further, the message 514 includes a notification within the graphical user interface of the client device 520 of the specific tenant environment with general and additional details regarding the scanned data for the first subset of domains 510.

According to one or more aspects, the parallel web scanning system 102 utilizes the scanner 502 to generate the message 514 for publishing web data to the tenant database 512 according to the scan request. For instance, the scanner 502 generates a separate message for each entity detected in the scanned data of the first subset of domains 510. To illustrate, the scanner 502 can generate a message based on a cookie detected in the web data. In one or more aspects, the message includes, but is not limited to, a cookie name, a host system/device including the cookie, a resource associated with the cookie, whether the cookie is a privacy policy cookie, whether the cookie is secure, and an expiration of the cookie.

Alternatively, as shown in FIG. 5, in some aspects, the parallel web scanning system 102 utilizes a batcher 516 to batch entities such as cookies, tags, forms, and storage. For instance, rather than sending a message to the client device 520 for each cookie data object, the parallel web scanning system 102 batches together cookies and sends a single message to indicate the entire batch of cookies, which can include a predetermined number of cookies (and/or additional entities) to group together. Furthermore, the parallel web scanning system 102 utilizes batches to efficiently send messages corresponding to a group of entities.

In some instances, the parallel web scanning system 102 utilizes the batcher 516 to track a predetermined threshold number of entities. In response to the parallel web scanning system 102 extracting data that satisfies a batching threshold, the batcher 516 generates a message 518 that corresponds to the entire batch of predetermined entities. Further, the parallel web scanning system 102 then sends the message 518 to the client device 520 via the batcher 516.

Moreover, in some aspects, the parallel web scanning system 102 generates the message 518 in response to extracted data of the first subset of domains 510 being published to the tenant database 512. In some such aspects, the parallel web scanning system 102 utilizes the batcher 516 to batch together a predetermined number of cookie/tags/forms/storage entities from the extracted data (e.g., 100 cookie entities) and generates the message 518 relating to the predetermined number of cookie entities.

In one or more additional aspects, the parallel web scanning system 102 utilizes the scanner 502 to process web data in batches. In particular, the parallel web scanning system 102 can dynamically determine a number of entities to batch together in a single message (e.g., utilizing Java Database Connectivity (“JDBC” batching). For example, the parallel web scanning system 102 can determine a batch size based on available resources (e.g., CPU capabilities, storage availability at an intermediate database or the tenant database 512). To illustrate, the scanner 502 can generate messages including batches of 50 scanned entities, 100 scanned entities, etc. By batching the entities/messages for processing, the parallel web scanning system 102 can improve performance (e.g., reduce CPU load) at one or more databases by reducing the number of separate communications sent between the different devices/systems while continuing to process additional data from the same scan request in parallel.

In one or more aspects, the parallel web scanning system 102 generates the message 518 (e.g., one or more messages) for the first subset of domains 510 corresponding to the cookies, tags, forms, or storages of the first subset of domains 510. In particular, in some aspects, the parallel web scanning system 102 generates the message 518 in response to publishing extracted data of the first subset of domains 510 to the tenant database 512. Moreover, in some such aspects, the parallel web scanning system 102 provides the message 518 to the client device 520.

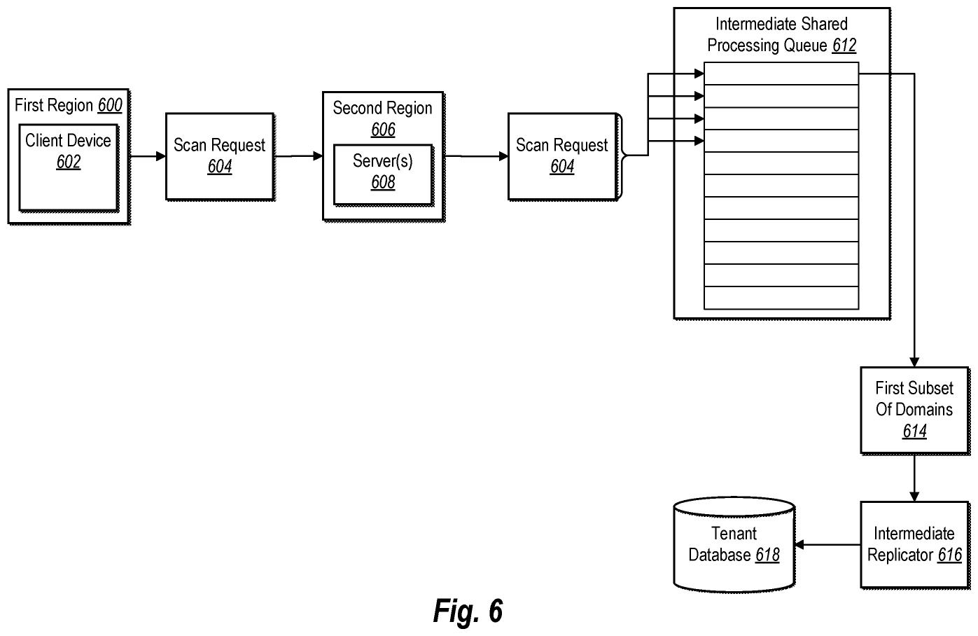

FIG. 6 illustrates the parallel web scanning system 102 utilizing an intermediate replicator in accordance with one or more aspects. In one or more aspects, the parallel web scanning system 102 utilizes an intermediate replicator 616 to replicate data across regions for scanned web data. For example, the parallel web scanning system 102 can receive a request from a particular region (e.g., U.S.) for a scanner that includes servers located in a different region (e.g., Europe). To preserve region compatibility, the parallel web scanning system 102 can scan web data in a first region (e.g., the region where the scanner system is located) and utilize the intermediate replicator 616 to replicate the scanned web data from the first region to a second region (e.g., the region where the request originated).

As shown in FIG. 6, the parallel web scanning system 102 allows for a client device 602 associated with a specific tenant environment to send a scan request 604 in a location different from where the client device 602 is located. In doing so, this allows a client device 602 to simulate domain/web browsing experiences in different geographic regions. For instance, the parallel web scanning system 102 provides an option via a graphical user interface of a client device 602 that includes selecting a server region from which to send the scan request 604.

As shown in FIG. 6, the client device 602 in a first region 600 sends the scan request 604 via server(s) 608 located in a second region 606. In one or more aspects, a region includes a delineated geographical area. For instance, a region can include North America, Europe, or Africa. More specifically, a region can include smaller areas such as the U.S. or the Southern U.S.

Furthermore, as shown, the parallel web scanning system 102 receives the scan request 604 from the server(s) 608 in the second region 606. Moreover, the parallel web scanning system 102 assigns one or more partitions of an intermediate shared processing queue 612 to the scan request 604. Specifically, FIG. 6 shows the parallel web scanning system 102 assigning four partitions to the scan request 604. As the parallel web scanning system 102 extracts first data from a first subset of domains 614 of the scan request 604, or otherwise prior to publishing to a tenant database 618, the parallel web scanning system 102 utilizes the intermediate replicator 616 in the manner described above. To illustrate, the parallel web scanning system 102 converts the first data of the first subset of domains 614 to be compatible with the first region 600 and publishes the first data to the tenant database 618 utilizing the intermediate replicator 616.

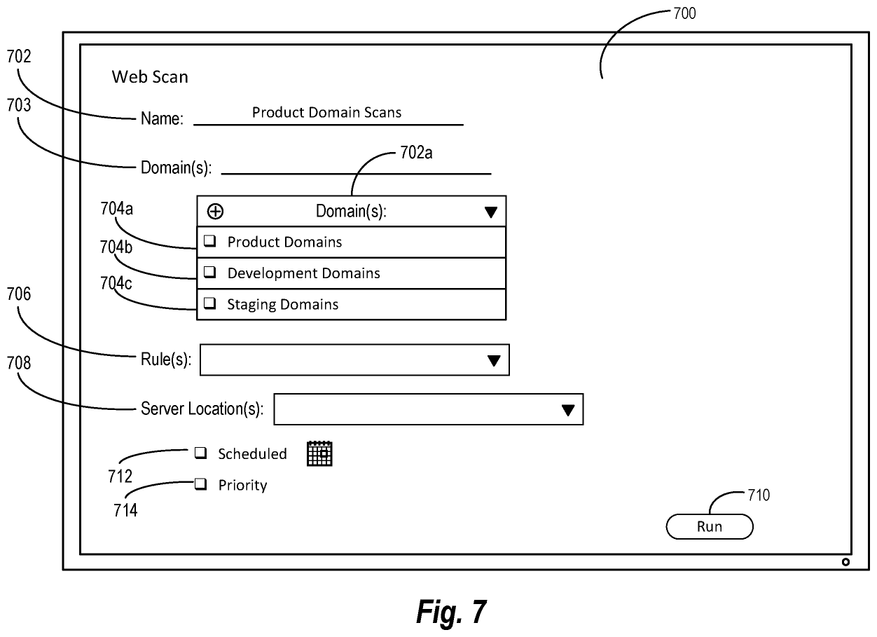

As mentioned above, a user of a client device associated with a specific tenant environment can configure a scan request for the parallel web scanning system 102. FIG. 7 illustrates the parallel web scanning system 102 providing, for display via a graphical user interface of a client device associated with a specific tenant environment, a scan configuration interface in accordance with one or more aspects.

As shown in FIG. 7, the parallel web scanning system 102 provides, via a graphical user interface 700, a name 702 for the scan request. For instance, FIG. 7 shows the name 702 as “product domain scans.” Moreover, FIG. 7 shows the parallel web scanning system 102 provides via the graphical user interface 700 a selection of domain(s). In particular, the parallel web scanning system 102 provides a table 702a that includes a list of previously scanned domains and an option to add additional domains not previously scanned. For instance, the parallel web scanning system 102 can receive a selection of one or more of the domains in the table 702a. Furthermore, the parallel web scanning system 102 provides a domain input line 703 to receive a manual input of a new set of domains not previously processed.

To illustrate, FIG. 7 shows the table 702a that includes product domains 704a, development domains 704b, and staging domains 704c. Further, FIG. 7 shows the parallel web scanning system 102 receiving a selection of product domains 704a for scanning. In one or more aspects, the parallel web scanning system 102 can receive a selection of the development domains 704b, the staging domains 704c, and/or other domain(s) not shown in addition to the product domains 704a.

Moreover, FIG. 7 shows the parallel web scanning system 102 providing rule(s) 706 for selection via the graphical user interface 700. For instance, the rule(s) 706 include the parallel web scanning system 102 providing options to scan for specific types of entities (e.g., cookies, tags, forms, or storage) or to perform specific acts such as categorizing or analyzing entities in regard to a downstream operations that utilize the entities.

Additionally, FIG. 7 shows the parallel web scanning system 102 providing an option for selecting server location(s) 708 via the graphical user interface 700. For instance, selecting a location from the server location(s) 708 relates to the discussion in FIG. 6. Specifically, the server location(s) 708 allows a client device associated with the specific tenant environment to indicate a specific geographic location to perform the scan request.

Furthermore, FIG. 7 shows the parallel web scanning system 102 providing an option via the graphical user interface 700 to indicate a scan request as scheduled 712 or priority 714. For instance, in response to the parallel web scanning system 102 receiving a selection of the scheduled 712 option, the parallel web scanning system 102 causes the graphical user interface 700 to display a calendar for selecting a specific date and time in the future. Moreover, in response to the parallel web scanning system 102 receiving a selection of the priority 714 option, the parallel web scanning system 102 can override other pending scans from the client device in response to receiving a selection of a run option 710.

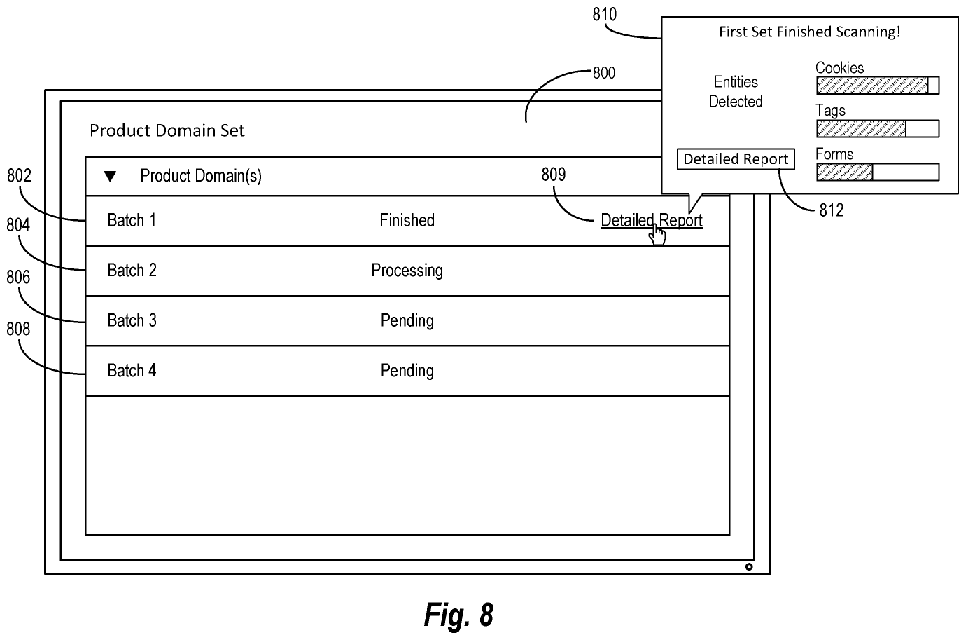

FIG. 8 illustrates the parallel web scanning system 102 providing a scanning results dashboard via a graphical user interface in accordance with one or more aspects. For example, FIG. 8 shows the parallel web scanning system 102 providing, for display via a graphical user interface 800 of a client device, the progress of a scan request. For instance, FIG. 8 shows different batches of a scan request (e.g., a subset of domains of the scan request) and the progress associated with each of the different batches. To illustrate, FIG. 8 shows a first batch 802 with a progress of “finished.” Further, FIG. 8 shows a second batch 804 processing and a third batch 806 and a fourth batch 808 pending. In one or more aspects, the parallel web scanning system 102 extracts data for the second batch 804 in parallel with publishing the data of the first batch 802 to a tenant database (and generating one or more messages associated with publishing the first batch 802 to the tenant database).

Furthermore, FIG. 8 shows for the first batch 802 a detailed report link 809. For example, in response to a selection of the detailed report link 809, the client device transitions the graphical user interface 800 to an additional user interface that contains various results corresponding to the first batch 802. Specifically, the client device displays various results corresponding to the first batch 802 including detailed analysis of the first batch's conformity with certain requirements, categorization of entities within the first batch 802, and/or replication of all data associated with the first batch 802. Moreover, upon a user of the graphical user interface 800 hovering over the detailed report link 809, the parallel web scanning system 102 provides a snapshot display 810 of the results corresponding to the first batch 802 for display at the client device. For instance, the snapshot display 810 can include various detected entities and another link 812 that also transitions the user to the additional user interface with additional information associated with the first batch 802.

In one or more aspects, the parallel web scanning system 102 utilizes processed web data (e.g., the processed web data from the first batch 802) including information about entities detected in the web data to modify the web data. For example, within the detailed report user interface, the parallel web scanning system 102 can provide options to modify web data. For instance, in response to detecting cookies, tags, storage, or forms in a web page, the parallel web scanning system 102 provides an option to modify the webpage or a resource associated with the webpage based on the entity. To illustrate, the parallel web scanning system 102 can send data to a host associated with an entity to insert additional data with the entity for presentation with the webpage.

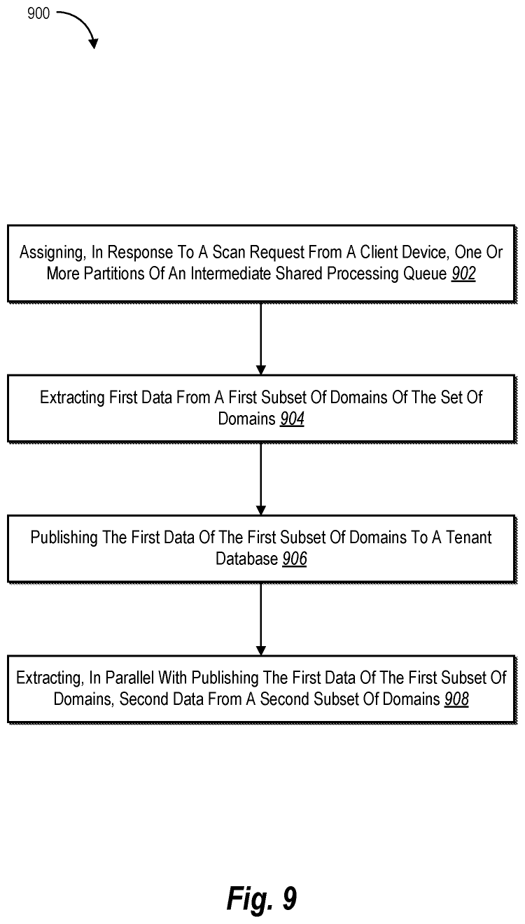

Turning now to FIG. 9, this figure shows a flowchart of a process 900 of processing and publishing data associated with separate subsets of domains in parallel via a parallel processing/publishing infrastructure. While FIG. 9 illustrates acts according to one aspect, alternative aspects may omit, add to, reorder, and/or modify any of the acts shown in FIG. 9. The acts of FIG. 9 can be performed as part of a method. Alternatively, a non-transitory computer readable medium can comprise instructions, that when executed by one or more processors, cause a computing device to perform the acts of FIG. 9. In still further aspects, a system can perform the acts of FIG. 9.

As shown, the process 900 includes an act 902 of assigning, in response to a scan request from a client device, one or more partitions of an intermediate shared processing queue. In some aspects, act 902 is implemented using one or more examples described above with respect to FIGS. 2, 3 and 4. The process 900 also includes an act 904 of extracting first data from a first subset of domains of the set of domains. In one or more aspects, act 904 is implemented using one or more examples described above with respect to FIGS. 2, 5 and 6.

Additionally, the process 900 includes an act 906 of publishing the first data of the first subset of domains to a tenant database. In one or more aspects, act 906 is implemented using one or more examples described above with respect to FIGS. 2, 5, and 6. The process 900 also includes an act 908 of extracting, in parallel with publishing the first data of the first subset of domains, second data from a second subset of domains. In one or more aspects, act 908 is implemented using one or more examples described above with respect to FIGS. 2 and 9.

In one or more aspects, the process 900 includes determining the one or more partitions from a plurality of partitions of the intermediate shared processing queue to assign based on a number of domains associated with the scan request. The process 900 further includes assigning an additional one or more partitions from a plurality of partitions of the intermediate shared processing queue in response to receiving an additional scan request from the client device. The process 900 also includes determining, for the scan request, a classification comprising one of a user-initiated scan request, a scheduled request, or a priority request. The process 900 also includes assigning the one or more partitions to the set of domains indicated by the scan request based on the classification of the scan request.

The process 900 can include receiving a first additional scan request that comprises the user-initiated scan request. For example, the process 900 can include receiving a second additional scan request that comprises the priority request. The process 900 can also include extracting, by the one or more servers, data of the second additional scan request prior to extracting data of the first additional scan request. For example, the process 900 can include replicating data associated with the first subset of domains. The process 900 can also include analyzing the data associated with the first subset of domains. Moreover, the process 900 can include categorizing the data associated with the first subset of domains.

The process 900 can include extracting at least one of cookies, tags, forms, or storages from the first subset of domains. The process 900 can further include generating one or more messages for the first data corresponding to one of cookies, tags, forms, or storages of the first data. The process 900 can also include providing, to the client device, the one or more messages comprising an indication of the first data published to the tenant database.

Additionally, the process 900 can include generating a message that corresponds to a batch of a predetermined number of entities of extracted data. The process 900 can include determining one or more entities of the first data exceeds a predetermined number of characters. The process 900 can also include generating a hash value for the one or more entities that exceeds the predetermined number of characters. Further, the process 900 includes publishing to the tenant database corresponding with the client device, the hash value for the one or more entities that exceeds the predetermined number of characters.

The process 900 can include assigning, by one or more servers in response to a scan request from a client device, one or more partitions of an intermediate shared processing queue to a set of websites indicated by the scan request to scan web data associated with the set of websites. The process 900 can also include extracting, by the one or more servers, first web data from a first subset of websites of the set of websites comprising at least one of cookies, tags, forms, or storages via the one or more partitions of the intermediate shared processing queue.

The process 900 can further include publishing, by the one or more servers, the first web data of the first subset of websites to a tenant database associated with the client device. The process 900 can also include generating a message indicating scanning information for the first web data of the first subset of websites to provide to the client device. Moreover, the process 900 can include extracting, by the one or more servers in parallel with publishing the first web data of the first subset of websites, second data from a second subset of websites of the set of websites via the one or more partitions of the intermediate shared processing queue.

The process 900 can include assigning one or more partitions by identifying a number of websites associated with the scan request. The process 900 can include determining, for the scan request, a classification comprising one of a user-initiated scan request, a scheduled request, or a priority request. Moreover, the process 900 can include determining the one or more partitions from a plurality of partitions of the intermediate shared processing queue to assign based on the number of web sites and the classification of the scan request.

In one or more aspects, the process 900 includes extracting the first web data of the first subset of websites of the set of websites by categorizing data associated with the first subset of web sites. The process 900 can also include generating, for the first web data, a message corresponding to a batch of extracted data that includes one or more of cookies, tags, forms, or storages. Additionally, the process 900 can include providing, to the client device, the message comprising an indication of the first web data published to the tenant database.

The process 900 can also include determining a predetermined number of scan requests for the client device. Additionally, the process 900 can include preventing a scan request from being assigned partitions of the intermediate shared processing queue in response to determining that an additional scan request from the client device reaches the predetermined number of scan requests.

The process 900 can further include receiving the scan request originating from the client device in a first region from one or more servers of a second region. The process 900 can also include replicating the first web data from the first subset of websites of the set of websites of the scan request utilizing an intermediate replicator to replicate the first web data in the second region to be compatible with the first region. Additionally, the process 900 can include generating, for display at the client device, one or more messages for the first data corresponding to one of cookies, tags, forms, or storages of the first data.

The process 900 can also include identifying a number of domains associated with the scan request. Additionally, the process 900 can include determining, for the scan request, a classification comprising one of a user-initiated scan request, a scheduled request, or a priority request. Moreover, the process 900 can include assigning the one or more partitions to the set of domains indicated by the scan request based on the classification of the scan request and the number of domains.

In one or more aspects, the process 900 includes assigning an additional one or more partitions from a plurality of partitions of the intermediate shared processing queue in response to receiving an additional scan request from the client device. The process 900 can also include generating, for display at the client device, one or more messages for the first data corresponding to one of cookies, tags, forms, or storages of the first data.

Aspects of the present disclosure may comprise or utilize a special purpose or general-purpose computer including computer hardware, such as, for example, one or more processors and system memory, as discussed in greater detail below. Aspects within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, aspects of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some aspects, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Aspects of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of exemplary computing device 1000 that may be configured to perform one or more of the processes described above. One will appreciate that one or more computing devices such as the computing device 1000 may implement the system(s) of FIG. 1. As shown by FIG. 10, the computing device 1000 can comprise a processor 1002, a memory 1004, a storage device 1006, an I/O interface 1008, and a communication interface 1010, which may be communicatively coupled by way of a communication infrastructure 1012. In certain aspects, the computing device 1000 can include fewer or more components than those shown in FIG. 10. Components of the computing device 1000 shown in FIG. 10 will now be described in additional detail.

In one or more aspects, the processor 1002 includes hardware for executing instructions, such as those making up a computer program. As an example, and not by way of limitation, to execute instructions for dynamically modifying workflows, the processor 1002 may retrieve (or fetch) the instructions from an internal register, an internal cache, the memory 1004, or the storage device 1006 and decode and execute them. The memory 1004 may be a volatile or non-volatile memory used for storing data, metadata, and programs for execution by the processor(s). The storage device 1006 includes storage, such as a hard disk, flash disk drive, or other digital storage device, for storing data or instructions for performing the methods described herein.

The I/O interface 1008 allows a user to provide input to, receive output from, and otherwise transfer data to and receive data from computing device 1000. The I/O interface 1008 may include a mouse, a keypad or a keyboard, a touch screen, a camera, an optical scanner, network interface, modem, other known I/O devices or a combination of such I/O interfaces. The I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain aspects, the I/O interface 1008 is configured to provide graphical data to a display for presentation to a user. The graphical data may be representative of one or more graphical user interfaces and/or any other graphical content as may serve a particular implementation.

The communication interface 1010 can include hardware, software, or both. In any event, the communication interface 1010 can provide one or more interfaces for communication (such as, for example, packet-based communication) between the computing device 1000 and one or more other computing devices or networks. As an example, and not by way of limitation, the communication interface 1010 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 1010 may facilitate communications with various types of wired or wireless networks. The communication interface 1010 may also facilitate communications using various communication protocols. The communication infrastructure 1012 may also include hardware, software, or both that couples components of the computing device 1000 to each other. For example, the communication interface 1010 may use one or more networks and/or protocols to enable a plurality of computing devices connected by a particular infrastructure to communicate with each other to perform one or more aspects of the processes described herein.

In the foregoing specification, the present disclosure has been described with reference to specific exemplary aspects thereof. Various aspects and aspects of the present disclosure(s) are described with reference to details discussed herein, and the accompanying drawings illustrate the various aspects. The description above and drawings are illustrative of the disclosure and are not to be construed as limiting the disclosure. Numerous specific details are described to provide a thorough understanding of various aspects of the present disclosure.

The present disclosure may be embodied in other specific forms without departing from its spirit or essential characteristics. The described aspects are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
assigning, by one or more servers in response to a scan request from a client device, one or more partitions of an intermediate shared processing queue to a set of domains indicated by the scan request to scan data associated with the set of domains;
extracting, by the one or more servers, first data from a first subset of domains of the set of domains via the one or more partitions of the intermediate shared processing queue;
publishing, by the one or more servers, the first data of the first subset of domains to a tenant database associated with the client device; and
extracting, by the one or more servers in parallel with publishing the first data of the first subset of domains, second data from a second subset of domains of the set of domains via the one or more partitions of the intermediate shared processing queue.

2. The computer-implemented method of claim 1, wherein assigning the one or more partitions further comprises determining the one or more partitions from a plurality of partitions of the intermediate shared processing queue to assign based on a number of domains associated with the scan request.

3. The computer-implemented method of claim 1, further comprises assigning an additional one or more partitions from a plurality of partitions of the intermediate shared processing queue in response to receiving an additional scan request from the client device.

4. The computer-implemented method of claim 1, wherein assigning the one or more partitions to the set of domains indicated by the scan request further comprises:
determining, for the scan request, a classification comprising one of a user-initiated scan request, a scheduled request, or a priority request; and
assigning the one or more partitions to the set of domains indicated by the scan request based on the classification of the scan request.

5. The computer-implemented method of claim 4, further comprises:
receiving a first additional scan request that comprises the user-initiated scan request;
receiving a second additional scan request that comprises the priority request; and
extracting, by the one or more servers, data of the second additional scan request prior to extracting data of the first additional scan request.

6. The computer-implemented method of claim 1, wherein extracting first data of the first subset of domains of the set of domains further comprises at least one of:
replicating data associated with the first subset of domains;
analyzing the data associated with the first subset of domains; or
categorizing the data associated with the first subset of domains.

7. The computer-implemented method of claim 1, wherein extracting the first data from the first subset of domains of the set of domains comprises extracting at least one of cookies, tags, forms, or storages from the first subset of domains.

8. The computer-implemented method of claim 1, wherein publishing to the tenant database further comprises:
generating one or more messages for the first data corresponding to one of cookies, tags, forms, or storages of the first data; and
providing, to the client device, the one or more messages to the client device which notifies the client device regarding the first data published to the tenant database.

9. The computer-implemented method of claim 8, wherein generating the one or more messages further comprises generating a message that corresponds to a batch of a predetermined number of entities of extracted data.

10. The computer-implemented method of claim 1, wherein publishing the first data of the first subset of domains to the tenant database further comprises:
determining one or more entities of the first data exceeds a predetermined number of characters;
generating a hash value for the one or more entities that exceeds the predetermined number of characters; and
publishing to the tenant database corresponding with the client device, the hash value for the one or more entities that exceeds the predetermined number of characters.

11. A system comprising:
one or more non-transitory computer readable media; and
processing hardware configured to cause the system to:
assign, by one or more servers in response to a scan request from a client device, one or more partitions of an intermediate shared processing queue to a set of websites indicated by the scan request to scan web data associated with the set of websites;
extract, by the one or more servers, first web data from a first subset of websites of the set of websites comprising at least one of cookies, tags, forms, or storages via the one or more partitions of the intermediate shared processing queue;
publish, by the one or more servers, the first web data of the first subset of websites to a tenant database associated with the client device;
generate a message indicating scanning information for the first web data of the first subset of websites to provide to the client device; and
extract, by the one or more servers in parallel with publishing the first web data of the first subset of websites, second data from a second subset of websites of the set of websites via the one or more partitions of the intermediate shared processing queue.

12. The system of claim 11, wherein the processing hardware is configured to cause the system to assign the one or more partitions by:
identifying a number of websites associated with the scan request;
determining, for the scan request, a classification comprising one of a user-initiated scan request, a scheduled request, or a priority request; and
determining the one or more partitions from a plurality of partitions of the intermediate shared processing queue to assign based on the number of websites and the classification of the scan request.

13. The system of claim 12, wherein the processing hardware is configured to cause the system to extract the first web data of the first subset of websites of the set of websites by categorizing data associated with the first subset of websites.

14. The system of claim 11, wherein the processing hardware is configured to cause the system to:
generate, for the first web data, a message corresponding to a batch of extracted data that includes one or more of cookies, tags, forms, or storages; and
provide, to the client device, the message which notifies the client device regarding the first web data published to the tenant database.

15. The system of claim 11, wherein the processing hardware is configured to cause the system to:
determine a predetermined number of scan requests for the client device; and
prevent a scan request from being assigned partitions of the intermediate shared processing queue in response to determining that an additional scan requests from the client device reaches the predetermined number of scan requests.

16. The system of claim 11, wherein the processing hardware is configured to cause the system to:
receive the scan request originating from the client device in a first region from one or more servers of a second region; and
replicate the first web data from the first subset of websites of the set of websites of the scan request utilizing an intermediate replicator to replicate the first web data in the second region to be compatible with the first region.

17. A non-transitory computer-readable medium storing executable instructions which, when executed by a processing device, cause the processing device to perform operations comprising:
assigning, by one or more servers in response to a scan request from a client device, one or more partitions of an intermediate shared processing queue to a set of domains indicated by the scan request to scan data associated with the set of domains;
extracting, by the one or more servers, first data from a first subset of domains of the set of domains via the one or more partitions of the intermediate shared processing queue;
publishing, by the one or more servers, the first data of the first subset of domains to a tenant database associated with the client device; and
extracting, by the one or more servers in parallel with publishing the first data of the first subset of domains, second data from a second subset of domains of the set of domains via the one or more partitions of the intermediate shared processing queue.

18. The non-transitory computer-readable medium of claim 17, wherein assigning the one or more partitions further comprises:
identifying a number of domains associated with the scan request;
determining, for the scan request, a classification comprising one of a user-initiated scan request, a scheduled request, or a priority request; and
assigning the one or more partitions to the set of domains indicated by the scan request based on the classification of the scan request and the number of domains.

19. The non-transitory computer-readable medium of claim 17, further comprises assigning an additional one or more partitions from a plurality of partitions of the intermediate shared processing queue in response to receiving an additional scan request from the client device.

20. The non-transitory computer-readable medium of claim 17, wherein publishing to the tenant database further comprises generating, for display at the client device, one or more messages for the first data corresponding to one of cookies, tags, forms, or storages of the first data.
